(19) United States
(12) Patent Application Publication
(10) Pub. No.: US 2020/0014294 A1
(43) Pub. Date: Jan. 9, 2020

(54) SURGE PROTECTION CIRCUIT FOR SWITCHED-MODE POWER SUPPLIES

(71) Applicant: QUALCOMM Incorporated, San Diego, CA (US)

(72) Inventors: Chunping SONG, Sunnyvale, CA (US); Ye Ming LI, Santa Clara, CA (US); Guoyong GUO, San Jose, CA (US)

(21) Appl. No.: 16/371,851

(22) Filed: Apr. 1, 2019

Related U.S. Application Data
(60) Provisional application No. 62/694,633, filed on Jul. 6, 2018.

(51) Int. Cl. H02M 1/32; H02J 7/00; H02M 3/158

(52) U.S. Cl. CPC H02M 1/32; H02J 7/0029; H02J 2007/0059; H02M 3/158; H02J 7/0052

(57) ABSTRACT

Certain aspects of the present disclosure generally relate to methods and apparatus for providing surge protection for a switched-mode power supply (SMPS), such as a SMPS used in a battery-charging circuit. One example surge protection circuit generally includes an input node; an output node; a reference potential node; a transistor coupled between the input node and the output node; a diode device having an anode coupled to the input node and a cathode coupled to a control node of the transistor; a voltage-clamping circuit coupled between the output node and the control node; and a first switch coupled between the control node of the transistor and the reference potential node.

### CROSS-REFERENCE TO RELATED APPLICATIONS

The present application claims the benefit of U.S. Provisional Patent Application Ser. No. 62/694,633, filed Jul. 6, 2018 and entitled “Surge Protection Circuit for Switched-Mode Power Supplies,” which is herein incorporated by reference in its entirety.

### TECHNICAL FIELD

Certain aspects of the present disclosure generally relate to electronic circuits and, more particularly, to surge protection circuits for switched-mode power supplies.

### BACKGROUND

A voltage regulator ideally provides a constant direct current (DC) output voltage regardless of changes in load current or input voltage. Voltage regulators may be classified as either linear regulators or switching regulators. While linear regulators tend to be small and compact, many applications may benefit from the increased efficiency of a switching regulator. A switching regulator may be implemented by a switched-mode power supply (SMPS), such as a buck converter. In some cases, the switching regulator may include a surge protection circuit to protect the switching regulator from voltage spikes

Power management integrated circuits (power management ICs or PMICs) are used for managing the power requirement of a host system. A PMIC may be used in battery-operated devices, such as mobile phones, tablets, laptops, wearables, etc., to control the flow and direction of electrical power in the devices. The PMIC may perform a variety of functions for the device such as DC-to-DC conversion (e.g., using a voltage regulator as described above), battery charging, power-source selection, voltage scaling, power sequencing, etc.

### SUMMARY

Certain aspects of the present disclosure generally relate to techniques and apparatus for providing surge protection for a switched-mode power supply, such as a battery-charging circuit.

Certain aspects of the present disclosure provide a surge protection circuit. The surge protection circuit generally includes an input node; an output node; a reference potential node; a transistor coupled between the input node and the output node; a diode device having an anode coupled to the input node and a cathode coupled to a control node of the transistor; a voltage-clamping circuit coupled between the output node and the control node; and a first switch coupled between the control node of the transistor and the reference potential node.

Certain aspects of the present disclosure provide a method for surge protection of a circuit. The method generally includes operating a transistor coupled between an input node and an output node of a surge protection circuit in an off state during an overvoltage condition at the input node; based on a first voltage at the input node falling with respect to a second voltage at the output node during the overvoltage condition, clamping a voltage difference between the second voltage at the output node and a third voltage at a control node of the transistor to a first clamping voltage; and turning on the transistor when a voltage difference between the third voltage at the control node and the first voltage at the input node reaches a threshold voltage of the transistor to discharge the second voltage at the output node through the transistor.

Certain aspects of the present disclosure provide a surge protection circuit. The surge protection circuit generally includes an input node; an output node; a transistor coupled between the input node and the output node; means for clamping a voltage difference between a first voltage at the output node and a second voltage at a control node of the transistor to a first clamping voltage during an overvoltage condition; means for following a third voltage at the input node with the second voltage at the control node when the third voltage is higher than the second voltage; and means for turning off the transistor during the overvoltage condition.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a block diagram of an example device that includes a surge protection circuit, in accordance with certain aspects of the present disclosure.

FIG. 2 is an example circuit diagram of an overvoltage protection surge test being applied to a battery-charging circuit with surge protection.

FIG. 3 is an example timing diagram illustrating USBIN and USBIN_MID waveforms for the circuit of FIG. 2 during three different phases of an overvoltage protection surge test.

FIG. 4 is a circuit diagram of an example surge protection circuit added to a battery-charging circuit, in accordance with certain aspects of the present disclosure.

FIG. 5 is an example timing diagram illustrating USBIN, USBIN_MID, and reverse-blocking field-effect transistor (RBFET) gate waveforms for the circuit of FIG. 4 during a surge event, in accordance with certain aspects of the present disclosure.

FIG. 6 is a flow diagram of example operations for surge protection of a circuit, in accordance with certain aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

### An Example Device

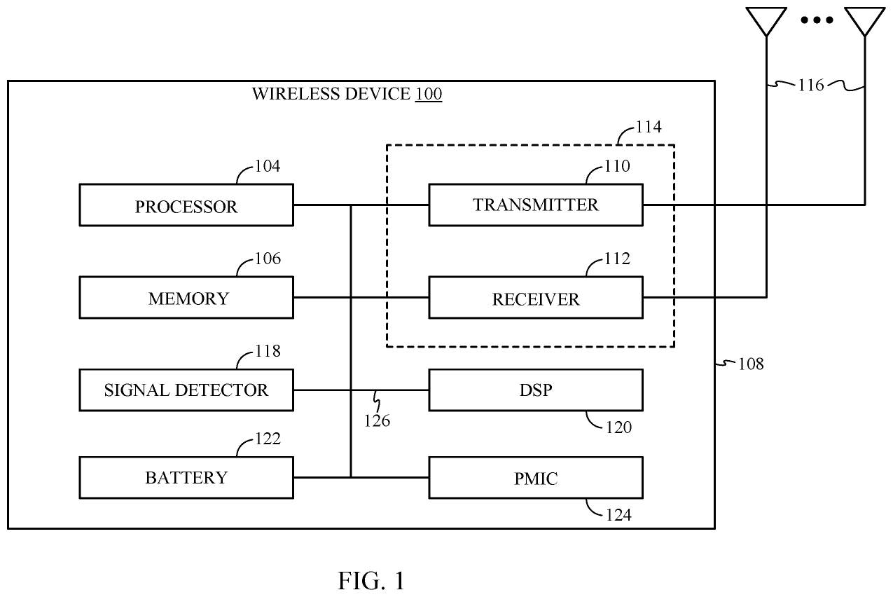

FIG. 1 illustrates an example device 100 in which aspects of the present disclosure may be implemented. For example, the device 100 may be a battery-operated portable device, such as a cellular phone, a personal digital assistant (PDA), a handheld device, a wireless device, a laptop computer, a tablet, a smartphone, etc.

The device 100 may include a processor 104 that controls operation of the device 100. The processor 104 may also be referred to as a central processing unit (CPU). Memory 106, which may include both read-only memory (ROM) and random access memory (RAM), provides instructions and data to the processor 104. A portion of the memory 106 may also include non-volatile random access memory (NVRAM). The processor 104 typically performs logical and arithmetic operations based on program instructions stored within the memory 106.

In certain aspects, the device 100 may also include a housing 108 that may include a transmitter 110 and a receiver 112 to allow transmission and reception of data between the device 100 and a remote location. For certain aspects, the transmitter 110 and receiver 112 may be combined into a transceiver 114. One or more antennas 116 may be attached or otherwise coupled to the housing 108 and electrically connected to the transceiver 114. The device 100 may also include (not shown) multiple transmitters, multiple receivers, and/or multiple transceivers.

The device 100 may also include a signal detector 118 that may be used in an effort to detect and quantify the level of signals received by the transceiver 114. The signal detector 118 may detect such signal parameters as total energy, energy per subcarrier per symbol, and power spectral density, among others. The device 100 may also include a digital signal processor (DSP) 120 for use in processing signals.

The device 100 may further include a battery 122 used to power the various components of the device 100. The device 100 may also include a power management integrated circuit (power management IC or PMIC) 124 for managing the power from the battery to the various components of the device 100. The PMIC 124 may perform a variety of functions for the device such as DC-to-DC conversion, battery charging, power-source selection, voltage scaling, power sequencing, etc. In certain aspects, the PMIC 124 may include a battery-charging circuit (e.g., a master-slave battery-charging circuit) or other switched-mode power supply. For certain aspects, the battery-charging circuit or other switched-mode power supply may include a surge protection circuit, as described below. The various components of the device 100 may be coupled together by a bus system 126, which may include a power bus, a control signal bus, and/or a status signal bus in addition to a data bus.

### Example Surge Protection Circuit

In order to charge the battery (e.g., battery 122) in a portable device, a battery-charging circuit may be utilized. For certain aspects, the battery-charging circuit may reside in a PMIC (e.g., PMIC 124). The battery-charging circuit may comprise, for example, one or more charge pump converters and/or one or more switched-mode power supplies (e.g., a buck converter). For certain aspects, the battery-charging circuit may comprise two or more parallel charging circuits, each capable of charging the battery, which may be connected together and to the battery in an effort to provide fast charging of the battery. Example parallel battery-charging circuits are described in U.S. Pat. No. 9,590,436 to Sporck et al., filed Apr. 11, 2014 and entitled “Master-Slave Multi-Phase Charging.” Conventional charging circuits, like those described in U.S. Pat. No. 9,590,436, for a parallel charger may use buck converter topologies. However, one of the buck converters may be replaced with a charge pump converter in some parallel charging circuits.

For mobile applications, for example, it may be desirable for a battery-charging circuit to pass at least a 100 V surge test applied to the input node (e.g., the USBIN pin), regardless whether the battery-charging circuit is in an ON or an OFF condition. One example surge test standard is the International Electrotechnical Commission (IEC) 61000-4-5. Per the IEC 61000-4-5, combination waveform generators are used to produce a specified open loop surge voltage waveform. For example, the 1.2/50 μs voltage surge waveform produces a rising wavefront that peaks at 1.2 μs±30% and a falling wavefront that reduces to half of the peak voltage at 50 μs±20%.

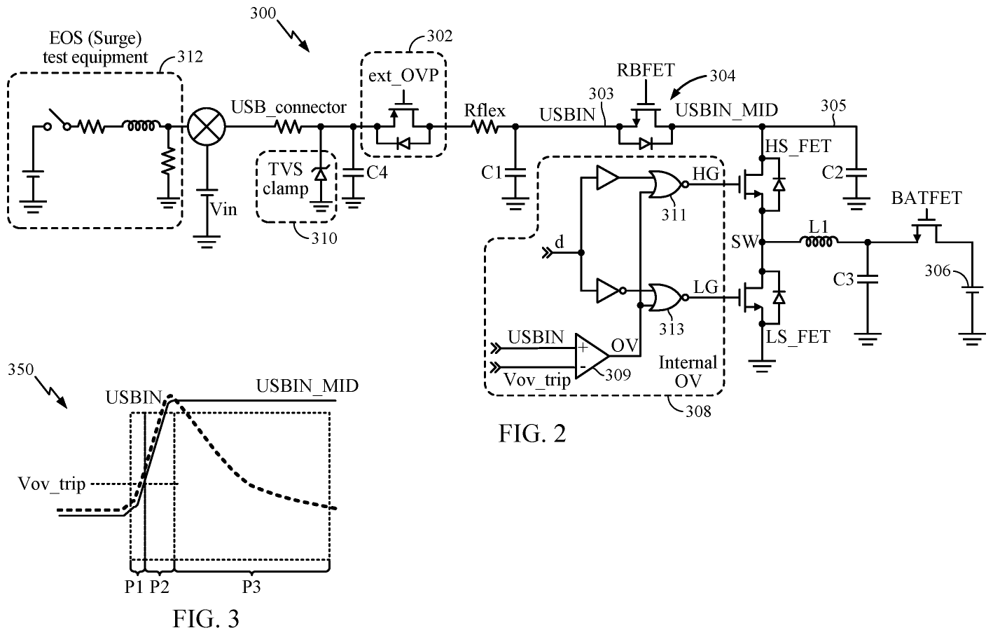

FIG. 2 is an example circuit diagram 300 of an overvoltage protection surge test being applied to a battery-charging circuit with surge protection. The battery-charging circuit includes a reverse blocking field-effect transistor (RBFET) 304 (also known as a front-porch field-effect transistor (FPFET)), a buck converter, logic 308 for controlling the high-side and low-side field-effect transistors (labeled “HS_FET” and “LS_FET”) in the buck converter, an inductor L1, a battery field-effect transistor (BATFET), and various capacitors C1, C2, and C3. The load for the battery-charging circuit is a battery 306, as shown in FIG. 2. The source of the RBFET 304 is connected to a USBIN node 303, and the drain of the RBFET 304 is connected to a USBIN_MID node 305. The body diode of the RBFET 304 prevents current from the battery 306 traveling through the HS_FET's body diode and into the USBIN node when the potential of the battery is higher than the USBIN potential. The surge protection circuit may include a transient voltage suppressor (TVS) 310, which may be implemented by a transient-voltage suppression diode (e.g., with a clamping voltage of 28 V), as illustrated in FIG. 2. The transient-voltage suppression clamp has an anode coupled to a reference potential node (e.g., electrical ground) for the circuit and a cathode coupled to an input node for the battery-charging circuit. In FIG. 2, the TVS 310 is connected in parallel with a capacitor C4 and is shunt-connected to a node between a USB connector and the resistance (Rflex) of the USB cable. To conduct the surge test, electrical overstress (EOS) test equipment 312 may be coupled to the USB connector, as illustrated.

FIG. 3 is an example timing diagram 350 illustrating USBIN and USBIN_MID voltage waveforms for the circuit of FIG. 2 during three different phases (P1, P2, and P3) of an overvoltage protection (OVP) surge test. During the first phase P1, the voltage of USBIN rises above a predetermined voltage threshold (labeled “Vov_trip”) due to the voltage surge input by the surge test equipment (e.g., EOS test equipment 312). The increase of USBIN above Vov_trip causes a comparator 309 in the logic 308 to output a logic HIGH signal (indicating an overvoltage (OV) condition) and effectively disable the gate drivers 311, 313 for the high-side and low-side FETs. Thus, the battery-charging circuit, including the RBFET 304, switches from ON to OFF due to the internal OV trip. During the second phase P2, the USBIN voltage rises to a peak voltage (e.g., according to the clamping voltage of the TVS 310), and the USBIN_MID voltage follows, based on the diode drop across the forward-biased body diode of the RBFET 304. During the third phase P3, the USBIN voltage falls due to the surge pull-down resistance of the shunt resistor in the test equipment 312, as well as the resistance in the USB connector and the resistance Rflex of the cable, for example. However, the USBIN_MID voltage will stay constant, since there is nothing to pull down the USBIN_MID voltage. Therefore, during phase P3, the RBFET 304 can be damaged if the difference between the USBIN_MID voltage and the USBIN voltage (e.g., the drain-to-source voltage (V_{DS})) exceeds the breakdown voltage of the RBFET.

It may be desirable to use an RBFET with a lower voltage rating to reduce die size and with a very low drain-to-source on-resistance (R_{DSon}), such as 10 mΩ to 25 mΩ, for increased power supply efficiency. To prevent damaging the RBFET during the surge test (or an actual surge condition), one solution entails adding an overvoltage protection circuit 302 (e.g., an external OVP IC) in front of the USBIN node 303, as shown in FIG. 2. However, this solution may increase the bill of materials (BOM), cause extra power loss, and expand the area of the printed circuit board (PCB) layout. An alternative or additional solution is to increase the RBFET's reverse blocking voltage capability by using a power FET with a sufficient breakdown voltage rating. For example, a 5 V complementary metal-oxide-semiconductor (CMOS) RBFET could be replaced with a 20 V high voltage laterally diffused metal-oxide semiconductor (LDMOS) RBFET. However, this solution may increase the die size of the battery-charging circuit, as well as cost. For example, to support a breakdown voltage of 28 V, there will be about a 1 mm² die area increase.

Certain aspects of the present disclosure provide a surge protection circuit that can automatically sense the USBIN voltage ramping down below the USBIN_MID voltage during phase P3 and can then turn on the RBFET to ramp down the USBIN_MID voltage accordingly to make sure the voltage difference between USBIN_MID and USBIN is below the breakdown voltage of the RBFET. This surge protection circuit may also ensure that the USBIN_MID voltage is higher than the battery voltage when the USBIN_MID voltage ramps down during phase P3. This prevents reverse current flowing from the battery to the USBIN_MID node via the body diode of HS_FET and discharging the battery. At the same time, the surge protection circuit described herein does not interfere with normal operation of the battery-charging circuit.

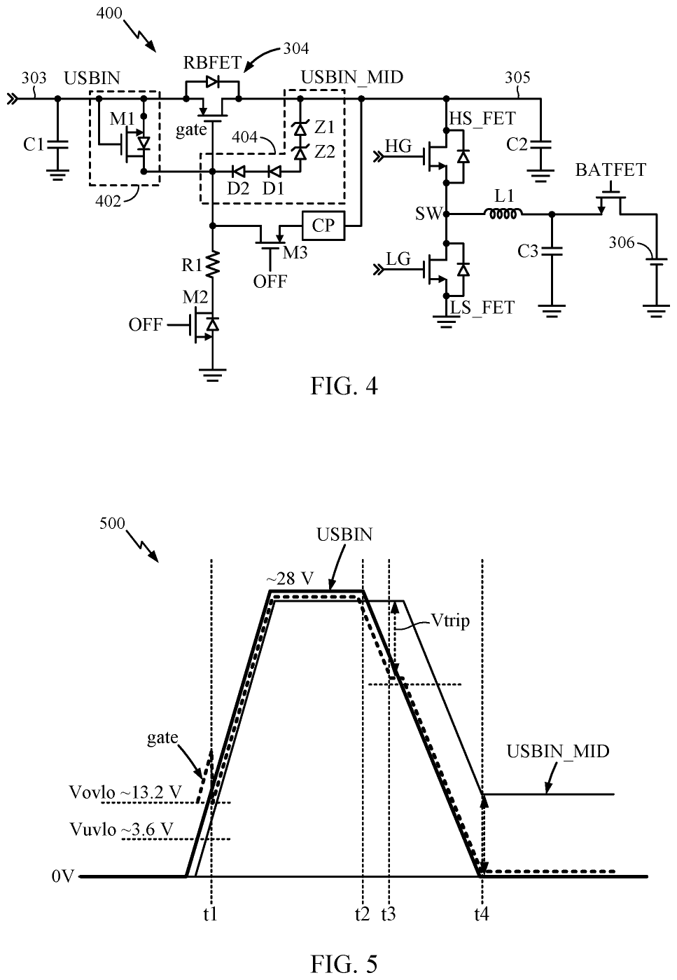

FIG. 4 is a circuit diagram 400 of an example surge protection circuit added to a battery-charging circuit, in accordance with certain aspects of the present disclosure. The surge protection circuit includes a diode device 402, a voltage-clamping circuit 404, a resistive element (e.g., resistor R1), and a first switch (e.g., switch implemented by transistor M2). The surge protection circuit may also include a second switch (e.g., switch implemented by transistor M3) and a charge pump (labeled “CP”). The switch and the charge pump may be used during normal operation of the battery-charging circuit to turn on the RBFET. The diode device 402 may be implemented, for example, by at least diode-connected transistor (e.g., transistor M1 having its gate and source connected together, as illustrated) and/or by one or more diodes. The voltage-clamping circuit 404 may be implemented by Zener diodes Z1 and Z2 connected in series with forward-biased diodes D1 and D2, as illustrated in FIG. 4. Although two Zener diodes and two forward-biased diodes are illustrated in the voltage-clamping circuit 404 of FIG. 4, the voltage-clamping circuit may include any number of desired diodes or other suitable devices to set the clamping voltage (e.g., referred to herein as “Vtrip”) of the surge protection circuit to a desired voltage level. Vtrip may be set below the breakdown voltage of the RBFET 304 to avoid damage to the RBFET. For example, Vtrip may be set to about 13.8 V when the breakdown voltage of the RBFET is 15 V. This Vtrip of 13.8 V may be accomplished using two Zener diodes having Zener voltages of about 6.3 V and two forward-biased diodes with forward voltages of about 0.6 V. Vtrip may also be set higher than the charged battery voltage to prevent discharging of the battery during a surge event.

FIG. 5 is an example timing diagram 500 illustrating USBIN, USBIN_MID, and RBFET gate voltage waveforms for the circuit diagram 400 of FIG. 4 during a surge event, in accordance with certain aspects of the present disclosure. Before time t1, the RBFET gate voltage will follow the USBIN voltage until the USBIN voltage crosses an undervoltage lockout (UVLO) threshold voltage (Vuvlo), at which point the gate voltage jumps to a new level to turn on the RBFET 304. When the USBIN voltage is above the UVLO threshold voltage and below an overvoltage lockout (OVLO) threshold voltage (Vovlo), the battery-charging circuit is in normal operation with RBFET turned ON. For certain aspects, Vovlo may be set at about 13.2 V, whereas Vuvlo may be set at about 3.6 V.

At time t1, the USBIN voltage crosses the OVLO threshold voltage, indicating an overvoltage event, such as a voltage surge. When the USBIN voltage rises above the OVLO threshold voltage (e.g., during a surge test or a real surge condition during operation), the battery-charging circuit turns off, and the RBFET turns off, as well. Logic 308 may be responsible for turning off the battery-charging circuit, as described above (e.g., by tripping the comparator 309), whereas the first switch (e.g., implemented by transistor M2) may be controlled by logic (e.g., going logical high) to turn off the RBFET. The USBIN_MID voltage ramps up between times t1 and t2 by following the USBIN voltage up, due to the body diode of the RBFET. Eventually, the USBIN voltage is clamped by the TVS 310 (e.g., at −28 V or another suitable clamping voltage).

At time t2, the USBIN voltage starts to ramp down due to the surge pull-down resistance, and the gate voltage of the RBFET follows the USBIN voltage ramping down. However, the USBIN_MID voltage initially stays at its peak value due to no available discharging path. Thus, the USBIN_MID voltage will be higher than the USBIN and gate voltages after time t2, as shown. With the USBIN voltage falling, the difference between the USBIN_MID and USBIN (and gate) voltages starts to increase between times t2 and t3.

At time t3, the difference between the USBIN_MID and gate voltages reaches the clamp voltage (Vtrip) of the voltage-clamping circuit 404. At this point, the gate voltage of the RBFET will not ramp down any more by following the USBIN voltage. Instead the gate voltage will be clamped to USBIN_MID-Vtrip.

After time t3, the USBIN voltage continues falling while the gate voltage remains at USBIN_MID-Vtrip. Once the voltage difference between the gate voltage and the USBIN voltage reaches the threshold voltage (Vth) of the RBFET between t3 and t4, the RBFET turns on again, providing a discharging path for the USBIN_MID node. After this point in time, the USBIN_MID and gate voltages ramp down also with the USBIN voltage. The difference between the USBIN and USBIN_MID voltages is around Vtrip, which may most likely be designed to be below the breakdown voltage of the RBFET.

At time t4, the USBIN voltage reaches zero or near zero. Shortly after time t4, the gate voltage falls low enough to turn off the RBFET and disable the discharging path for the USBIN_MID node. Therefore, the USBIN_MID voltage may remain constant after time t4, as shown in FIG. 5. To keep the USBIN_MID voltage above the battery voltage (to prevent discharging the battery), Vtrip may be designed to be greater than the charged battery voltage.

The surge protection circuit described herein can handle at least a 500 V surge test with only an external TVS. The TVS may be considered external to the surge protection circuit because the TVS may be located in the charging cable or the adapter, whereas the surge protection circuit may be located in the device connected to the cable to be charged. The surge protection circuit may offer a reduced BOM by eliminating the external OVP IC (and related components) without increasing the die size. This saves money, reduces layout area, and simplifies customers' designs. Additionally, the surge protection circuit can save at least 1 mm² die size area by avoiding using a higher voltage RBFET and related circuitry, which can be more than 14% of the total area of the battery-charging circuit. Furthermore, no extra bias current is added during the off state of the charging circuit. The surge protection circuit described herein offers a robust and self-aligned design and operation without dedicated circuits, such as a reference generator and comparators. Moreover, there is no need for any test or configuration, saving test time and cost in production (e.g., no need to test a comparator to trip at a particular voltage). The surge protection circuit provides a flexible design that can be easily adjusted for different battery-charging circuits and other circuits employing switched-mode power supplies.

Certain aspects of the present disclosure provide a surge protection circuit. The surge protection circuit generally includes an input node (e.g., the USBIN node 303); an output node (e.g., the USBIN_MID node 305); a reference potential node (e.g., electrical ground); a transistor (e.g., an RBFET 304) coupled between the input node and the output node; a diode device (e.g., diode device 402, which may be implemented by diode-connected transistor M1) having an anode coupled to the input node and a cathode coupled to a control node (e.g., a gate) of the transistor; a voltage-clamping circuit (e.g., voltage-clamping circuit 404) coupled between the output node and the control node; and a first switch (e.g., transistor M2) coupled between the control node of the transistor and the reference potential node.

According to certain aspects, the surge protection circuit further includes a resistive element (e.g., resistor R1) having a first terminal and a second terminal. In this case, the first terminal may be coupled to the control node, and the second terminal may be coupled to the first switch.

According to certain aspects, the surge protection circuit further includes a transient voltage suppressor (TVS) (e.g., TVS 310). For certain aspects, the TVS comprises a transient-voltage-suppression diode. The transient-voltage-suppression diode may have an anode coupled to the reference potential node and a cathode coupled to the input node.

According to certain aspects, the surge protection circuit further includes a charge pump having an input and an output. The input of the charge pump may be coupled to the output node of the surge protection circuit. The surge protection circuit may also include a second switch coupled between the output of the charge pump and the control node of the transistor. For certain aspects, the surge protection circuit further includes logic, which may be configured to control closing of the first switch when a voltage at the input node exceeds a threshold voltage and/or to control opening of the second switch when the voltage at the input node exceeds the threshold voltage. For certain aspects, the logic is further configured to control opening of the first switch when the voltage at the input node is below the threshold voltage and/or to control closing of the second switch when the voltage at the input node is below the threshold voltage.

According to certain aspects, the voltage-clamping circuit includes one or more Zener diodes (e.g., Z1 and Z2). For certain aspects, the voltage-clamping circuit further comprises one or more forward-biased diodes (e.g., D1 and D2) coupled in series with the one or more Zener diodes.

According to certain aspects, a clamping voltage (Vtrip) of the voltage-clamping circuit is less than a breakdown voltage of the transistor.

According to certain aspects, the transistor comprises an n-channel metal-oxide-semiconductor field-effect transistor having a drain, a source, and a gate. In this case, the drain may be coupled to the output node of the surge protection circuit, the source may be coupled to the input node of the surge protection circuit, and/or the gate is the control node of the transistor.

According to certain aspects, the diode device includes a diode-connected transistor.

Certain aspects of the present disclosure provide a power management integrated circuit (PMIC) comprising at least a portion of the surge protection circuit described above.

Certain aspects of the present disclosure provide a portable device comprising the surge protection circuit described above. The portable device typically further includes a battery and a battery-charging circuit having an input coupled to the output node of the surge protection circuit and having an output coupled to the battery. For certain aspects, a clamping voltage of the voltage-clamping circuit is less than a breakdown voltage of the transistor. The clamping voltage of the voltage-clamping circuit may also be greater than a charged voltage of the battery. For certain aspects, the battery-charging circuit is implemented as a buck converter or another switched-mode power supply topology.

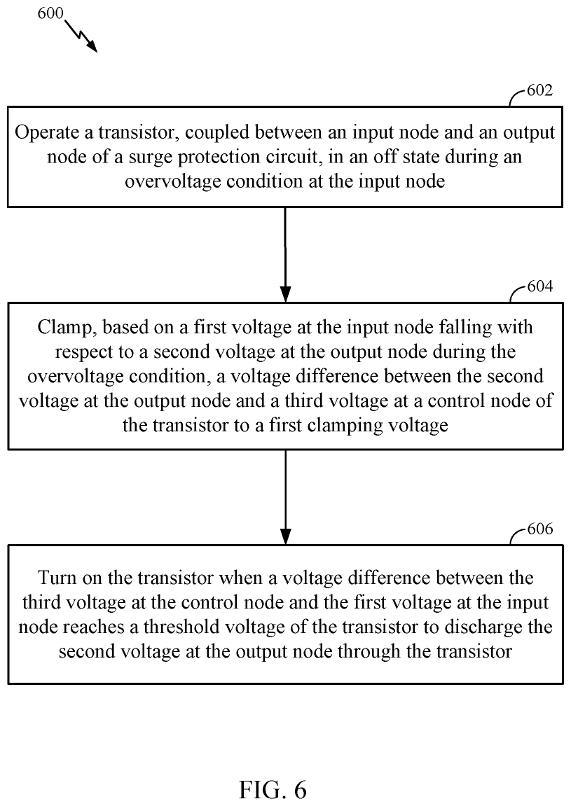

FIG. 6 is a flow diagram of example operations 600 for surge protection of a circuit, in accordance with certain aspects of the present disclosure. The operations 600 may be performed by a surge protection circuit, such as the surge protection circuit described above with respect to FIG. 4. The circuit being protected may be a battery-charging circuit or another circuit implemented by a switched-mode power supply, for example.

The operations 600 may begin, at block 602, with the surge protection circuit operating a transistor (e.g., RBFET 304) in an off state during an overvoltage condition at an input node (e.g., USBIN node 303) of the surge protection circuit. The transistor may be coupled between the input node and an output node (e.g., USBIN_MID node 305 of the surge protection circuit. Based on a first voltage (e.g., USBIN) at the input node falling with respect to a second voltage (e.g., USBIN_MID) at the output node during the overvoltage condition, the surge protection circuit clamps a voltage difference between the second voltage at the output node and a third voltage at a control node (e.g., gate) of the transistor to a first clamping voltage at block 604. At block 606, the surge protection circuit turns on the transistor when a voltage difference between the third voltage at the control node and the first voltage at the input node reaches a threshold voltage (Vₜₕ) of the transistor to discharge the second voltage at the output node through the transistor.

According to certain aspects, the first clamping voltage is set by a voltage-clamping circuit (e.g., voltage-clamping circuit 404) coupled between the output node of the surge protection circuit and the control node of the transistor.

According to certain aspects, the first clamping voltage is less than a breakdown voltage of the transistor.

According to certain aspects, the operations 600 may further involve the surge protection circuit determining that the first voltage at the input node has exceeded an overvoltage threshold voltage (e.g., Vov_trip or Vovlo). Based on the determination, the surge protection circuit may turn off the transistor to start the overvoltage condition, and the surge protection circuit may clamp the first voltage at the input node to a second clamping voltage (e.g., TVS clamping voltage) based on turning off the transistor. These processes may occur before block 602 in the operations 600. For certain aspects, the second clamping voltage is set by a transient voltage suppressor (e.g., TVS 310) coupled to the input node. For certain aspects, turning off the transistor entails opening a switch (e.g., switch implemented by transistor M2) coupled between the control node of the transistor and a reference potential node (e.g., electrical ground) for the surge protection circuit.

According to certain aspects, the third voltage at the control node follows the first voltage at the input node during the overvoltage condition—due to a diode device (e.g., diode device 402) having an anode coupled to the input node and a cathode coupled to the control node—until the clamping to the first clamping voltage.

The various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components with similar numbering.

For example, means for clamping may be implemented by a voltage-clamping circuit (e.g., the voltage-clamping circuit 404 as depicted in FIG. 4) or a transient voltage suppressor (e.g., the TVS 310 as illustrated in FIG. 2). Means for following may be implemented, for example, by a diode device (e.g., the diode device 402 as portrayed in FIG. 4). Means for turning off the transistor may be implemented, for example, by a switch or a transistor (e.g., transistor M2 as shown in FIG. 4).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A surge protection circuit comprising:
an input node;
an output node;
a reference potential node;
a transistor coupled between the input node and the output node;
a diode device having an anode coupled to the input node and a cathode coupled to a control node of the transistor;
a voltage-clamping circuit coupled between the output node and the control node; and
a first switch coupled between the control node of the transistor and the reference potential node.

2. The surge protection circuit of claim 1, further comprising a transient voltage suppressor (TVS) coupled to the input node.

3. The surge protection circuit of claim 2, wherein the TVS comprises a transient-voltage-suppression diode having an anode coupled to the reference potential node and a cathode coupled to the input node.

4. The surge protection circuit of claim 1, further comprising:
a charge pump having an input and an output, the input of the charge pump being coupled to the output node of the surge protection circuit; and
a second switch coupled between the output of the charge pump and the control node of the transistor.

5. The surge protection circuit of claim 4, further comprising logic configured to:
close the first switch when a voltage at the input node exceeds a threshold voltage; and
open the second switch when the voltage at the input node exceeds the threshold voltage.

6. The surge protection circuit of claim 5, wherein the logic is further configured to:
open the first switch when the voltage at the input node is below the threshold voltage; and
close the second switch when the voltage at the input node is below the threshold voltage.

7. The surge protection circuit of claim 1, wherein the voltage-clamping circuit comprises one or more Zener diodes.

8. The surge protection circuit of claim 7, wherein the voltage-clamping circuit further comprises one or more forward-biased diodes coupled in series with the one or more Zener diodes.

9. The surge protection circuit of claim 1, wherein a clamping voltage of the voltage-clamping circuit is less than a breakdown voltage of the transistor.

10. The surge protection circuit of claim 1, wherein:
the transistor comprises an n-channel metal-oxide-semiconductor field-effect transistor having a drain, a source, and a gate;
the drain is coupled to the output node of the surge protection circuit;
the source is coupled to the input node of the surge protection circuit; and
the gate comprises the control node of the transistor.

11. The surge protection circuit of claim 1, wherein the diode device comprises a diode-connected transistor.

12. The surge protection circuit of claim 1, wherein the transistor comprises a body diode having an anode coupled to the input node and a cathode coupled to the output node.

13. A power management integrated circuit (PMIC) comprising at least a portion of the surge protection circuit of claim 1.

14. A portable device comprising the surge protection circuit of claim 1, the portable device further comprising:
a battery; and
a battery-charging circuit having an input coupled to the output node of the surge protection circuit and having an output coupled to the battery.

15. The portable device of claim 14, wherein a clamping voltage of the voltage-clamping circuit is less than a breakdown voltage of the transistor and wherein the clamping voltage of the voltage-clamping circuit is greater than a charged voltage of the battery.

16. The portable device of claim 14, wherein the battery-charging circuit is implemented as a buck converter.

17. The portable device of claim 1, further comprising a resistive element coupled between the control node of the transistor and the first switch.

18. A method for surge protection of a circuit, comprising:
operating a transistor, coupled between an input node and an output node of a surge protection circuit, in an off state during an overvoltage condition at the input node;
based on a first voltage at the input node falling with respect to a second voltage at the output node during the overvoltage condition, clamping a voltage difference between the second voltage at the output node and a third voltage at a control node of the transistor to a first clamping voltage; and
turning on the transistor when a voltage difference between the third voltage at the control node and the first voltage at the input node reaches a threshold voltage of the transistor to discharge the second voltage at the output node through the transistor.

19. The method of claim 18, wherein the first clamping voltage is set by a voltage-clamping circuit coupled between the output node of the surge protection circuit and the control node of the transistor.

20. The method of claim 18, wherein the first clamping voltage is less than a breakdown voltage of the transistor.

21. The method of claim 18, further comprising:
determining that the first voltage at the input node has exceeded an overvoltage threshold voltage;
based on the determination, turning off the transistor to start the overvoltage condition; and
clamping the first voltage at the input node to a second clamping voltage based on turning off the transistor.

22. The method of claim 21, wherein the second clamping voltage is set by a transient voltage suppressor coupled to the input node.

23. The method of claim 21, wherein turning off the transistor comprises opening a switch coupled between the control node of the transistor and a reference potential node for the surge protection circuit.

24. The method of claim 18, wherein the third voltage at the control node follows the first voltage at the input node during the overvoltage condition due to a diode device having an anode coupled to the input node and a cathode coupled to the control node until the clamping to the first clamping voltage.

25. A surge protection circuit comprising:
an input node;
an output node;
a transistor coupled between the input node and the output node;
means for clamping a voltage difference between a first voltage at the output node and a second voltage at a control node of the transistor to a first clamping voltage during an overvoltage condition;
means for following a third voltage at the input node with the second voltage at the control node when the third voltage is higher than the second voltage; and
means for turning off the transistor during the overvoltage condition.

26. The surge protection circuit of claim 25, further comprising means for clamping the third voltage at the input node to a second clamping voltage, the second clamping voltage being higher than the first clamping voltage.

27. The surge protection circuit of claim 25, wherein the first clamping voltage is less than a breakdown voltage of the transistor.
